(19) United States
(12) Patent Application Publication
(10) Pub. No.: US 2007/0090740 A1
(43) Pub. Date: Apr. 26, 2007

(54) External electrode type discharge lamp

(75) Inventors: Takahiro Hiraoka, Hyogo (JP); Yukiharu Tagawa, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 11/500,444

(22) Filed: Aug. 8, 2006

(30) Foreign Application Priority Data
Aug. 8, 2005 (JP) JP2005-229804
Jun. 5, 2006 (JP) JP2006-155596

(51) Int. Cl. H01J 11/00; H01J 65/00; H01J 61/06

(52) U.S. Cl. 313/234; 313/607

(57) ABSTRACT

An external electrode type discharge lamp comprises a glass tube enclosing rare gas, a first electrode having a first end portion and a second electrode having a second end portion disposed on an surface of the glass tube in an axis direction the glass tube, wherein while the first end portion of the first electrode does not face the second electrode, the second end portion of the second electrode 2b does not face the first electrode.

### CROSS-REFERENCES TO A RELATED APPLICATION

This application claims priority from Japanese Patent Application Nos. 2005-229804 filed Aug. 8, 2005, and 2006-155596 filed Jun. 5, 2006, the contents of which are incorporated herein by reference in their entireties.

### TECHNICAL FIELD

The present invention relates to an external electrode type discharge lamp, and especially, to an external electrode type fluorescence lamp used as a light source of a scanner or a copying machine for scanning a document, an external electrode type fluorescence lamp used as a backlight for a liquid crystal display apparatus and an external electrode type excimer lamp used as a light source for UV washing.

### BACKGROUND

In recent years, an external electrode type discharge lamp in which a pair of strip electrodes is arranged on an external surface of a glass bulb, but metal steam such as mercury is not enclosed, is used as a light source of a scanner or a copying machine for scanning a document. A document is scanned by emitting light onto a document surface from a discharge lamp which is disposed below the surface of the document, and receiving the reflected light from the surface of the document by a CCD line sensor.

There are mainly two types of such lamps which have a pair of electrodes on the outer circumferential surface of a lamp arc tube respectively, one of which has the electrodes extending in the longitudinal direction of the arc tube as described in Japanese Laid Open Patent No. 11-54089, and the other of which has cap-shaped electrodes disposed at both ends of an arc tube, as described in Japanese Laid Open Patent No. No. 2002-8408. In the former one, the luminous efficiency of light emitted from the discharge lamp is high since an arc tube generates electric discharge from almost all over the area thereof. Moreover, since the external electrode type fluorescence lamp does not enclose mercury therein, it is a recent environment-conscious product, and application of such a lamp to a back light source of, for example, a liquid crystal display monitor, is expected.

However, when a pair of strip electrodes is arranged so as to face each other, there is a problem that the electric power supply structure thereof becomes complicated.

As shown in FIG. 5 of Japanese Laid Open Patent No. 11-54089, when a lead terminal is connected to an end portion of each electrode, a manufacturing process becomes complicated and a problem such as a fracture also occurs when wiring the lead at the time of use.

On the other hand, as shown in FIG. 1 of Japanese Laid Open Patent No. 11-54089, the electric power supply structure in which potentials of the electrodes are different from each other can also be realized by providing end caps that cover the end portions of an arc tube. However, in such a case, there is a problem that the electric power supply structure in the end caps becomes complicated. Also refer to U.S. Pat. No. 3,622,721.

### SUMMARY

It is an object of the present invention to offer an external electrode type discharge lamp having a simple structure which is easy to manufacture and has high of luminous efficiency.

In view of the above-mentioned problems, the object of the present invention is achieved by an external electrode type discharge lamp comprising a glass tube enclosing rare gas, a first electrode having a first end portion and a second electrode having a second end portion disposed on an surface of the glass tube in an axis direction the glass tube, wherein while the first end portion of the first electrode does not face the second electrode, the second end portion of the second electrode 2b does not face the first electrode.

In the external electrode type discharge lamp, an area per unit length of at least one of the first and second end portions may be greater than that of other portion thereof.

In the external electrode type discharge lamp, at least one of the first and second end portions may be formed in a ring shape on an outer circumferential surface of the glass tube.

With the above structure, the external electrode type discharge lamp according to the present invention is easy to manufacture and has a simple structure and high luminous efficiency.

Thus, the present invention possesses a number of advantages or purposes, and there is no requirement that every claim directed to that invention be limited to encompass all of them.

### BRIEF DESCRIPTION OF THE DRAWINGS

Other features and advantages of the present discharge lamp will be apparent from the ensuing description, taken in conjunction with the accompanying drawings, in which;

FIGS. 1A, 1B and 1C show an external electrode type discharge lamp according to the present invention;

FIG. 2 shows an electric power supply holder;

FIG. 3 shows another embodiment of an electrode of the external electrode type discharge lamp according to the present invention;

FIG. 4 shows still another embodiment of an external electrode type discharge lamp according to the present invention;

FIGS. 5A-5F show examples of a band shaped electrode of external electrode type discharge lamp according to the present invention; and

FIG. 6. shows a lamp apparatus, in which an external electrode type discharge lamp is held by an electric power supply holder at end portions of the lamp.

### DETAILED DESCRIPTION

While the claims are not limited to the illustrated embodiments, an appreciation of various aspects of the discharge lamp is best gained through a discussion of various examples thereof.

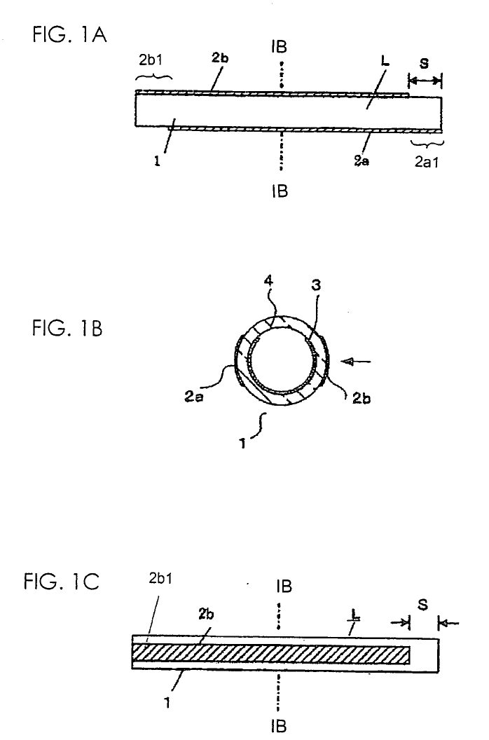

FIG. 1A shows a schematic top plan view of an external electrode type discharge lamp according to the present invention, and FIG 1B shows a cross-sectional view thereof taken along a line IB-IB of FIGS. 1A, 1C and 3, and FIG. 1C shows a schematic side view thereof, viewing it in a direction of an arrow of FIG. 1B.

As shown in the figures, a discharge lamp L comprises a tubular glass tube 1, and a pair of electrodes 2a and 2b formed on an external surface of the glass tube 1. The glass tube 1 is made of lead glass, and xenon gas or mixed gas whose main component is xenon gas is enclosed as rare gas therein.

As shown in FIG. 1B, a fluorescent substance (phosphors) is coated on an inner wall surface of the glass tube 1, so as to form a phosphor layer 3 therein, which has a C-shape in a cross-sectional view of the discharge lamp. The fluorescent substance having a luminescence peak near the wavelength of 550 nm is selected in case of a light source for a black-and-white document reader. An aperture section 4 on which the fluorescent substance is not coated is formed on the inner wall surface of the glass tube 1. In addition, the discharge lamp L will emit light due to the phosphor layer 3 formed thereon. Such a lamp is also called a rare-gas fluorescence lamp.

As shown in FIGS. 1A, 1B, and 1C, the electrodes 2a and 2b are formed in a strip-shape as a whole and extend on the outer wall of the glass tube 1 in an axial direction (longitudinal direction). These electrodes 2a and 2b are made from a conductive material member, such as metal tapes made of, for example, aluminum and copper or silver paste, etc. Moreover, a slit(s) or an opening(s) can be formed in the electrodes 2a and 2b. The slit or opening is provided so that light generated in the glass tube 1 is emitted from not only the aperture 4 but also the slit or opening. The technology of the electrodes having the slit etc. is described in, for example, Japanese Laid Open Patent No. H09-298049.

The discharge lamp generates dielectrics barrier electric discharge (barrier electric discharge) by using the glass tube 1 (glass material) sandwiched by the electrodes 2a and 2b as dielectrics, by impressing high-frequency voltage to these electrodes 2a and 2b, so as to have the fluorescent substance 6 coated on the inner surface of the glass, emit light due to ultraviolet rays generated by the discharge.

The glass tube 1 has, for example, the length of 370 mm, the outer-diameter of φ 10 mm, and the luminescence length of about 340 mm. The xenon gas enclosed in the glass tube 1 is selected from a range of 10 k to 100 k Pa, and, for example, the xenon of 50 kPa is enclosed therein. The width of the electrodes 2a and 2b is selected from a range of 3 to 10 mm, for example, 7 mm, and a rare-gas fluorescence lamp is turned on by rated lighting electric power of 26 W.

The discharge lamp can emit ultraviolet radiation, when a phosphor is not coated on the inner wall of the glass tube 1. This ultraviolet radiation is also called excimer light, and intense light having a single wavelength. The (single) wavelength of light varies, depending on the gas enclosed in the glass tube 1. In case of xenon gas (Xe), light having a wavelength of 172 nm is emitted. In case of argon gas (Ar), and chlorine gas (CL), light having a wavelength of 175 nm, is emitted. In the case of a krypton (Kr) and an iodine (I), light having a wavelength of 191 nm is emitted, and in case of an argon (Ar), and a fluorine (F), light having a wavelength of 193 nm, is emitted. In the case of a krypton (Kr) and a bromine (Br), light having a wavelength of 207 nm is emitted. In case of a krypton (Kr), and chlorine (CL), light having a wavelength of 222 nm is emitted. Since the glass tube 1 emits ultraviolet rays, quartz glass is used. This kind of excimer light can be used for UV washing of substances such as quartz glass, and surface-reforming of other materials.

As shown in FIGS. 1A and 1B, a pair of strip shaped electrodes are formed on the glass tube 1 in the longitudinal direction of the glass tube 1. Electric power is supplied from one end 2a1 of the electrode 2a. Electric power is supplied from one end 2b1 of the electrode 2b. That is, as shown in FIG. 1A, while the one end 2a1 of the electrode 2a does not face the other electrode 2b, the one end 2b1 of the other electrode 2b does not face the electrode 2a. In this embodiment, the pair of electrodes having an approximately strip-shape, extends in a longitudinal direction of the glass tube 1.

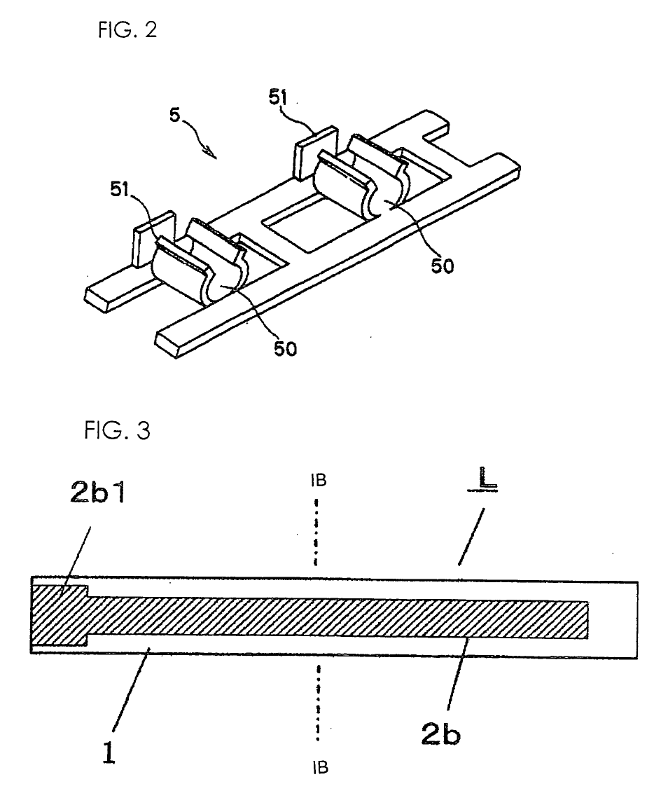

FIG. 2 shows an electric power supply holder 5 for holding the external electrode type discharge lamps according to the present invention. The electric power supply holder 5 is made from, for example, a conductive member(s), which is made of, for example, phosphor bronze, wherein the electric supply to the lamps and holding of the lamps can be attained simultaneously when those lamps L are held in the holder 5. The electric power supply holder 5 comprises a stopper 51 and a lamp receiving portion 50. The lamp discharge receiving portion 50 has an omega shape in a cross-section. When the discharge lamp L is held in the electric power supply holder 5, one electrode 2a comes into contact with the electric power supply holder 5, but the electrode 2b does not come in contact with the holder 5. Moreover, an electric power supply holder 5 is also arranged at the opposite side end of the discharge lamp L, wherein the electric power supply holder 5 is in contact with the other electrode 2b, but not in contact with the electrode 2a. According to the above described structure, the electric power is supplied to the electrode 2a of the discharge lamp at one of the electric power supply holders 5, and at the other end, the electric power supply holder 5 can supply electric power to the electrode 2b of the discharge lamp. In addition, the stopper 51 for the discharge lamps is formed in the electric power supply holder 5.

In FIG. 1, the length S of a portion where one end 2a1 faces but the electrode 2b is not provided, may be approximately equal to or greater than that of a discharge lamp holding portion of the holder 5 where the discharge lamp is placed. For example, the length S is, for example, about 5 to 10 mm, and if the stopper 51 is taken into consideration, it may be set to about 15 mm.

FIG. 3 shows another embodiment of the external electrode type discharge lamp according to the present invention.

The area of an end portion 2b1 of an electrode 2b is larger than that of the strip portion of the electrode 2b. When the discharge lamp L is held in the electric power supply holder 5, the advantage of the structure is that an area in contact with an electrode becomes large, and electric supply efficiency increases. In the figure, although only the electrode 2b is shown, the electrode 2a has the same structure as that of the electrode 2b, in which the area of the end portion of the electrode 2a is larger than other the strip portion.

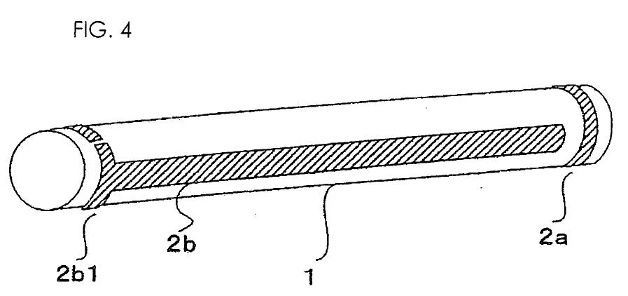

FIG. 4 shows still another embodiment of the external electrode type discharge lamp according to the present invention. The end portion 2b1 of the electrode 2b has a ring-like shape or an approximately ring-like shape, and the electric supply holder 5 comes in contacted with the entire portion of the ring. The advantage of this structure is also that the area in contact with the electrode becomes large, and electric supply efficiency increases similarly when it is held in the electric power supply holder 5. In the figure, although only the electrode 2b is shown, the electrode 2a has the same structure as that of the electrode 2b, in which the end portion of the electrode 2a has a ring-like shape or an approximately ring-like shape.

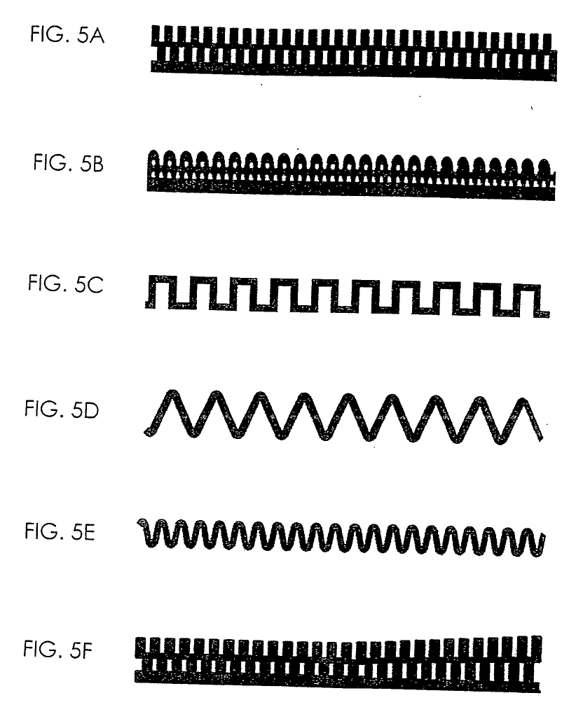

FIGS. 5A-5F show other embodiments of the electrode 2. The “strip” of the strip shape means shape determined by an envelope curve of the outer edge of electrode. That is, the strip shape shown in FIGS. 5A-5E. Further, as shown in FIG. 5F, the width of the strip is not necessarily the same. In FIG. 5F, the width of the strip gradually becomes larger from the left to right on the figure.

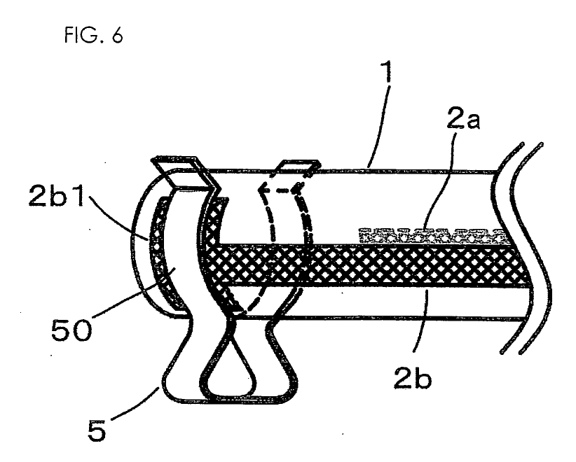

FIG. 6. shows a lamp apparatus, in which an external electrode type discharge lamp shown in FIG. 3 is held by an electric power supply holder at end portions of the lamp. The width of the end portion 2b1 of the electrode 2b is larger than the strip shape portion. The electric power supply holder 5 has holder portion 50 having elastic force. When the glass tube 1 of the lamp is inserted in the holder portion 50, the holder portion 50 is spread so that the lamp is held by the holder portion 50. At that time, although the electrode 2b comes in contact with the holding portion 50, the electrode 2a does not come in contact with the holding portion 50. Therefore, electric power supplied to the holding portion 50 is supplied to only the electrode 2b so that the electric power is not supplied to the electrode 2a. The holder 5 is arranged at both ends of the lamp as shown in FIG. 2. Moreover, the holder is arranged so as to extend in a direction perpendicular to the longitudinal direction of the lamp. The holder is monopole, wherein electric power is supplied to the electrode 2a at one end of the lamp and electric power is supplied to the electrode 2b at the other end of the lamp.

Thus, the external electrode type discharge lamp according to the present invention has a simple structure so that manufacturing process is simple, and it is possible to increase the luminous efficiency.

The preceding description has been presented only to illustrate and describe exemplary embodiments of the discharge lamp of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

1. An external electrode type discharge lamp comprising:
a glass tube enclosing rare gas;
a first electrode having a first end portion and a second electrode having a second end portion disposed on an surface of the glass tube in an axis direction the glass tube,
wherein while the first end portion of the first electrode does not face the second electrode, the second end portion of the second electrode 2b does not face the first electrode.

2. The external electrode type discharge lamp according to claim 1, wherein an area per unit length of at least one of the first and second end portions is greater than that of other portion thereof.

3. The external electrode type discharge lamp according to claim 2, wherein an area per unit length of at least one of the first and second end portions is greater than that of other portion thereof.

4. The external electrode type discharge lamp according to claim 1, wherein a width of at least one of the first and second end portions is greater than that of other portion thereof in a direction perpendicular to the axis direction.

5. The external electrode type discharge lamp according to claim 2, wherein a width of at least one of the first and second end portions is greater than that of other portion thereof in a direction perpendicular to the axis direction.

6. The external electrode type discharge lamp according to claim 1, wherein at least one of the first and second end portions is formed in a ring shape on an outer circumferential surface of the glass tube.

7. The external electrode type discharge lamp according to claim 2, wherein at least one of the first and second end portions is formed in a ring shape on an outer circumferential surface of the glass tube.

8. The external electrode type discharge lamp according to claim 3, wherein at least one of the first and second end portions is formed in a ring shape on an outer circumferential surface of the glass tube.

9. The external electrode type discharge lamp according to claim 4, wherein at least one of the first and second end portions is formed in a ring shape on an outer circumferential surface of the glass tube.

10. The external electrode type discharge lamp according to claim 1, further including an electric power supply holder.

11. The external electrode type discharge lamp according to claim 10, wherein the electric power supply holder comprises a stopper and a lamp receiving portion.

12. The external electrode type discharge lamp unit according claim 11, wherein the lamp receiving portion is formed in an omega shape in a cross-section.

13. A lamp apparatus having an external electrode type fluorescent lamp and a holder that holds both ends of the external electrode type fluorescent lamp so that electric power is supplied thereto,
wherein a pair of strip shape electrodes is formed in parallel to each other on a glass tube of the fluorescent lamp in an axis direction of the glass tube, and the glass tube contains rare gas,
wherein the holders are provided at both ends of the fluorescent lamp, each of which is monopole, and electric power is supplied to one of the pair of strip shape electrodes at one end of the fluorescent lamp, and to the other one of the pair of strip shape electrodes at the other end of the fluorescent lamp.
